(19) United States
(12) Patent Application Publication
(10) Pub. No.: US 2026/0229036 A1
(43) Pub. Date: Aug. 6, 2026

(54) INFORMATION PROCESSING DEVICE, ANALYSIS METHOD, AND RECORDING MEDIUM

(71) Applicant: NEC Corporation, Tokyo (JP)

(72) Inventors: Yoshitomo WARASHINA, Tokyo (JP); Rui KONDO, Tokyo (JP)

(73) Assignee: NEC Corporation, Tokyo (JP)

(21) Appl. No.: 19/445,859

(22) Filed: Jan. 12, 2026

(30) Foreign Application Priority Data
Feb. 4, 2025 (JP) 2025-016940

(51) Int. Cl. G06V 20/52; G06F 3/01; G06T 7/20; G06V 40/20

(52) U.S. Cl. CPC G06V 20/52; G06F 3/012; G06F 3/013; G06T 7/20; G06V 40/28; G06T 2207/30196; G06T 2207/30242

(57) ABSTRACT

An information processing device includes: at least one memory storing instructions; and at least one processor executing the instructions to: acquire a captured image of a vicinity of a display device displaying predetermined information; specify a number of people in the captured image; specify viewing times that the predetermined information has been viewed based on face direction or line of sight of each person in the captured image; specify recognition times that the predetermined information has been recognized based on predetermined motions indicating more intense gazing than viewing, made by each person in the captured image; and output the number of people, viewing times, and recognition times.

This application is based upon and claims the benefit of priority from Japanese Patent Application No. 2025-016940, filed on February 4, 2025, the disclosure of which is incorporated herein in its entirety by reference.

### TECHNICAL FIELD

The present disclosure relates to an information processing device and the like.

### BACKGROUND ART

There is a technique of analyzing what a person is looking at based on a line of sight of the person. For example, JP 2007-286995 A describes measuring an eye direction of a person and calculating attention position information of the person from the eye direction.

### SUMMARY

By the way, for example, it is difficult to perform analysis of an effect of information displayed on a display device installed at a place that can be seen by an unspecified number of people.

An object of the present disclosure is to provide an information processing device and the like that facilitate analysis of an effect of information displayed on a display device installed at a place that can be seen by an unspecified number of people.

An information processing device according to one aspect of the present disclosure includes an acquisition means for acquiring a captured image in which the vicinity of a display device that displays predetermined information is captured, a person presence status analysis means for specifying the number of people included in the captured image, a viewing status analysis means for specifying the number of times of viewing that the predetermined information has been viewed based on at least one of a direction of a face or a direction of a line of sight of each of the people included in the captured image, a recognition status analysis means for specifying the number of times of recognition that the predetermined information has been recognized based on a predetermined motion with which it is possible to determine that the predetermined information is more gazed at than the viewing, the predetermined motion being made by each of the people included in the captured image, and an output means for outputting the number of people, the number of times of viewing, and the number of times of recognition.

In an analysis method according to one aspect of the present disclosure, at least one computer executes processing of acquiring a captured image in which the vicinity of a display device that displays predetermined information is captured, specifying the number of people included in the captured image, specifying the number of times of viewing that the predetermined information has been viewed based on at least one of a direction of a face or a direction of a line of sight of each of the people included in the captured image, specifying the number of times of recognition that the predetermined information has been recognized based on a predetermined motion with which it is possible to determine that the predetermined information is more gazed at than the viewing, the predetermined motion being made by each of the people included in the captured image, and outputting the number of people, the number of times of viewing, and the number of times of recognition.

A program according to one aspect of the present disclosure causes at least one computer to execute processing of acquiring a captured image in which the vicinity of a display device that displays predetermined information is captured, specifying the number of people included in the captured image, specifying the number of times of viewing that the predetermined information has been viewed based on at least one of a direction of a face or a direction of a line of sight of each of the people included in the captured image, specifying the number of times of recognition that the predetermined information has been recognized based on a predetermined motion with which it is possible to determine that the predetermined information is more gazed at than the viewing, the predetermined motion being made by each of the people included in the captured image, and outputting the number of people, the number of times of viewing, and the number of times of recognition.

The program may be stored in a non-transitory recording medium readable by the at least one computer.

### BRIEF DESCRIPTION OF THE DRAWINGS

FIG. 1 is an explanatory diagram illustrating an exemplary information processing system including an information processing device;

FIG. 2 is a block diagram illustrating an exemplary configuration of the information processing device;

FIG. 3 is an explanatory view illustrating an exemplary predetermined range;

FIG. 4 is an explanatory view illustrating an exemplary predetermined range;

FIG. 5 is an explanatory diagram illustrating an example in which there are a plurality of predetermined ranges;

FIG. 6 is a flowchart illustrating an exemplary operation of the information processing device;

FIG. 7 is a block diagram illustrating an exemplary configuration of an information processing device;

FIG. 8 is an explanatory view illustrating an exemplary screen of a terminal;

FIG. 9 is a flowchart illustrating an exemplary operation of an information processing device; and

FIG. 10 is an explanatory diagram illustrating an exemplary hardware configuration of a computer.

### EXAMPLE EMBODIMENT

Hereinafter, example embodiments of an information processing device, an analysis method, a program, and a non-transitory recording medium storing the program according to the present disclosure will be described in detail with reference to the drawings. The respective example embodiments do not limit the disclosed technique.

### First Example Embodiment

In a first example embodiment, an exemplary basic function of an information processing device will be described in detail with reference to the drawings.

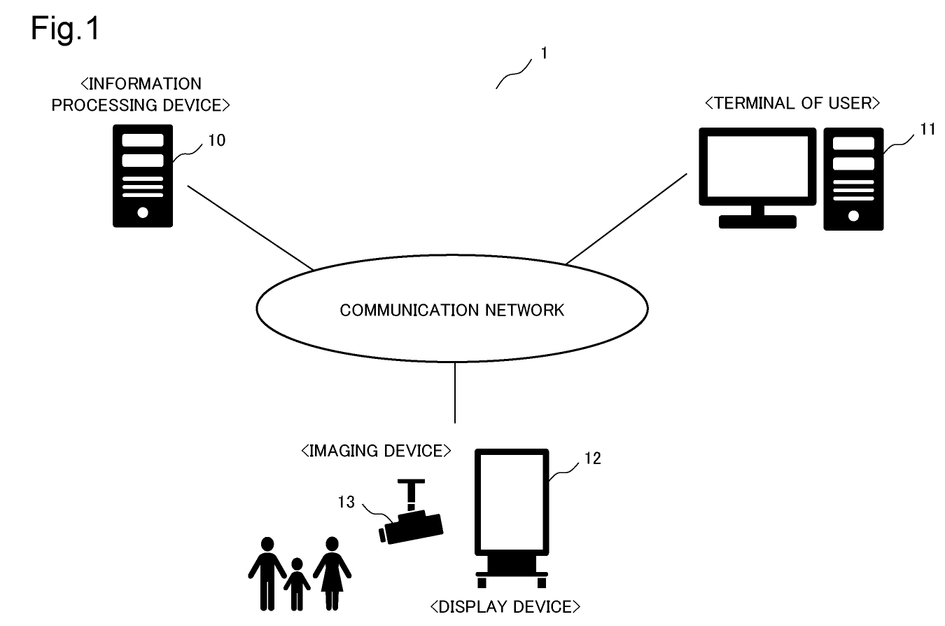

FIG. 1 is an explanatory diagram illustrating an exemplary information processing system including the information processing device. An information processing system 1 includes, for example, an information processing device 10, a terminal 11 of a user, a display device 12, and an imaging device 13.

The information processing device 10 is connected to the imaging device 13 and the display device 12 via a communication network. The display device 12 is installed at a place that can be viewed by an unspecified number of people. The place that can be viewed by the unspecified number of people is not particularly limited, and may be a retail store, a station, a square, a company, a road, and the like. More specifically, for example, the display device 12 may be installed on or in a building near a scramble intersection. People who look at information displayed on the display device 12 differ between a case where the display device 12 is installed in such a building and a case where the display device 12 is installed in a retail store. The display device 12 may be a digital signage, a large-screen display device installed on a building, or a small display device installed on a shelf of a retail store, and the type of the display device 12 is not particularly limited.

The imaging device 13 is installed so as to be capable of capturing an image of the vicinity of the display device 12. Note that the display device 12 and the imaging device 13 may be a single device.

The information processing device 10 is connected to the terminal 11 of the user via a communication network. The terminal 11 is, for example, the terminal 11 used by the user. The user may be, for example, an advertiser or the like, or may be a person in charge of analyzing a viewing effect of an advertisement or the like. The terminal 11 may be an output destination device to which information from the information processing device 10 is output, or may be an input source device that inputs information to the information processing device 10. For example, in the terminal 11, an application program capable of outputting information from the information processing device 10 or transmitting information to the information processing device 10 may be installed in advance. For example, the terminal 11 may access a site of the information processing device 10, which is a website, via a communication network NT. The type of the terminal 11 is not particularly limited, and may be a personal computer (PC), a smartphone, a tablet device, or the like. The number of the terminals 11 is not particularly limited.

The terminal 11 and the information processing device 10 may be a single device. The type of communication network such as a wired or wireless network is not particularly limited, and the communication network may be constituted by a plurality of communication networks. A configuration of the communication network by which the information processing device 10 is connected to the terminal 11 or the like is not particularly limited.

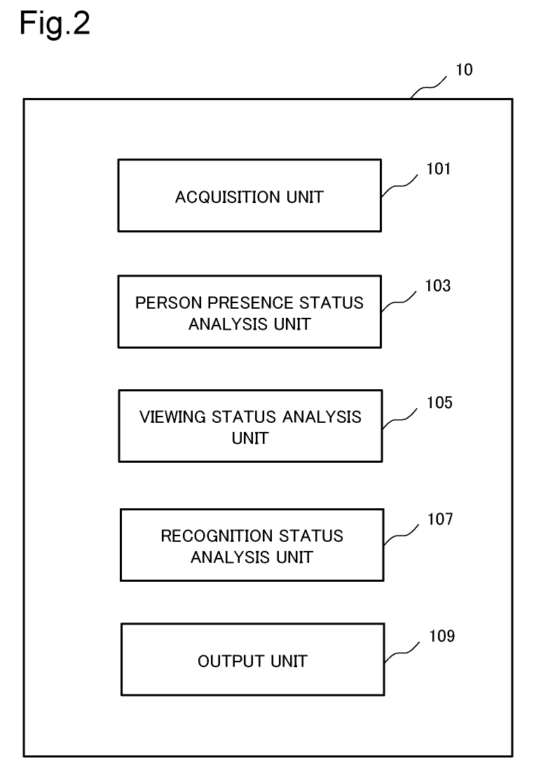

FIG. 2 is a block diagram illustrating an exemplary configuration of the information processing device 10. The information processing device 10 includes an acquisition unit 101, a person presence status analysis unit 103, a viewing status analysis unit 105, a recognition status analysis unit 107, and an output unit 109. Each functional unit appropriately stores a processing result, a processing intermediate result, and the like in a storage device or the like accessible by the information processing device 10.

The acquisition unit 101 acquires a captured image in which the vicinity of the display device 12 that displays predetermined information is captured. Specifically, for example, the acquisition unit 101 acquires the captured image from the imaging device 13 capable of capturing the image of the vicinity of the display device 12 that displays the predetermined information via a communication network. For example, the acquisition unit 101 may be capable of acquiring the captured image in real time.

The predetermined information displayed by the display device 12 is not particularly limited, but may be, for example, advertisement information.

The person presence status analysis unit 103 specifies a presence status of a person included in the acquired captured image. The presence status of the person included in the acquired captured image may be the number of people included in the captured image, or may be an extent or a range of the number of people included in the captured image. For example, the extent of the number of people included in the captured image may be about 100 people, several people, and the like, and the range of the number of people included in the captured image may be 0 to 10 people, 11 to 50 people, and the like. In the following description, the number of people included in the captured image will be described as an example. As a method of specifying the number of people, the person presence status analysis unit 103 may extract people included in the acquired captured image and count the number of extracted people.

The viewing status analysis unit 105 specifies a viewing status in which the predetermined information has been viewed based on at least one of a direction of a face and a direction of a line of sight of a person included in the captured image. The viewing status may be at least one of the number of times of viewing, the number of viewers, a viewing time, and a statistic of the viewing time, and is not particularly limited. The statistic is an average value, a median value, a mode value, a minimum value, a maximum value, or the like.

Here, viewing means that a person temporarily looks at the predetermined information. Recognition means that a person looks at the predetermined information more attentively than the viewing. Alternatively, the recognition means that a person looks at the predetermined information with interest as compared with the viewing.

Specifically, for example, the viewing status analysis unit 105 may specify whether a person included in the captured image is viewing the predetermined information depending on whether a face of the person included in the captured image is directed to the predetermined information. The viewing status analysis unit 105 may specify a person whose face is directed to the predetermined information among people included in the captured image as a person viewing the predetermined information. Specifically, for example, the viewing status analysis unit 105 may specify whether a person included in the captured image is viewing the predetermined information depending on whether a line of sight of the person included in the captured image is directed to the predetermined information.

In a case where the same person has viewed the predetermined information a plurality of times, the plurality of times are counted as the number of times of viewing. On the other hand, as for the number of viewers, even if the same person has viewed the predetermined information a plurality of times, the person is counted as one viewer.

The recognition status analysis unit 107 specifies the number of times of recognition that the predetermined information has been recognized based on a predetermined motion with which it is possible to determine that the predetermined information is more gazed at than the viewing, the predetermined motion being made by a person included in the captured image. For example, the predetermined motion is at least one of a motion of a person approaching the predetermined information, a motion of a person bringing the terminal 11 closer to the predetermined information, a motion of a person pointing his/her finger at the predetermined information, and a motion of the same person viewing the predetermined information a plurality of times. The predetermined motion is a motion of looking at the predetermined information for a time longer than a time determined as the viewing. For example, if the viewing is watching the predetermined information for about 1 second to 3 seconds, the recognition is looking at the predetermined information for 10 seconds or longer. Note that the predetermined motion is not limited to the examples described herein.

The recognition status analysis unit 107 may specify a person performing the predetermined motion as a recognized person from among the people included in the captured image.

In a case where the same person has recognized the predetermined information a plurality of times, the plurality of times are counted as the number of times of recognition. On the other hand, as for the number of recognized persons, even if the same person has recognized the predetermined information a plurality of times, the person is counted as one recognized person.

Here, a range that can be captured by the imaging device 13 may be wider than a range in which the predetermined information displayed on the display device 12 can be viewed. Even if a face of a person included in the captured image is directed to the predetermined information, there may be a case where the person does not actually look at the predetermined information. Similarly, even if a line of sight of a person included in the captured image is directed to the predetermined information, there may be a case where the person does not actually look at the predetermined information. Therefore, the range in which the predetermined information displayed on the display device 12 can be viewed may be determined in advance. This range is sometimes referred to as a predetermined range. The predetermined range may be a predetermined angle with respect to the display device 12. In addition, the predetermined range may be within a predetermined distance from the display device 12. In addition, the predetermined range may be a region in which the predetermined information is estimated to be viewable, the region being appropriately set by the user.

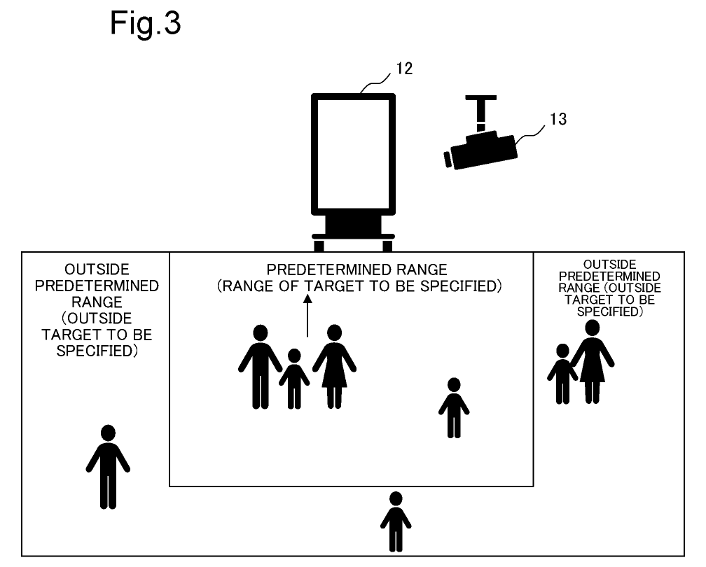

FIG. 3 is an explanatory view illustrating an exemplary predetermined range. In FIG. 3, the predetermined range is a region estimated to be viewable with respect to the display device 12. In FIG. 3, the predetermined range is a rectangular region.

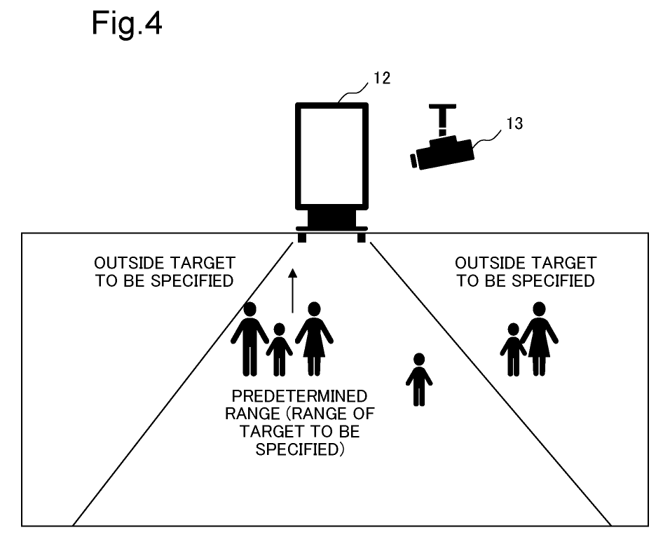

FIG. 4 is an explanatory view illustrating an exemplary predetermined range. In FIG. 4, the predetermined range is a range of a predetermined angle with respect to display device 12. The predetermined angle may be, for example, an angle based on an effective viewing angle of the display device 12. The angle based on the effective viewing angle may be the effective viewing angle itself or an angle narrower than the effective viewing angle.

In FIGS. 3 and 4, for example, a region within the predetermined range is a target to be specified for the viewing status or the recognition status. When the viewing status is the number of times of viewing, for example, the region within the predetermined range is a target subjected to counting of the number of times of viewing. When the recognition status is the number of times of recognition, for example, the region within the predetermined range is a target subjected to counting of the number of times of recognition.

The viewing status analysis unit 105 specifies the viewing status in which the predetermined information has been viewed based on at least one of a direction of a face and a direction of a line of sight of a person within the predetermined range among the people included in the captured image. For example, when the viewing status is the number of times of viewing, the viewing status analysis unit 105 specifies the number of times of viewing that the predetermined information has been viewed based on at least one of the direction of the face and the direction of the line of sight of the person within the predetermined range among the people included in the captured image.

The recognition status analysis unit 107 specifies the recognition status in which the predetermined information has been recognized based on a predetermined motion of a person within the predetermined range. For example, when the recognition status is the number of times of recognition, the recognition status analysis unit 107 specifies the number of times of recognition that the predetermined information has been recognized based on the predetermined motion of the person within the predetermined range.

There may be a plurality of predetermined ranges. Here, a case where two ranges of a first range and a second range are set as the predetermined ranges will be described as an example. The predetermined ranges include the first range in which the predetermined information can be viewed with respect to the display device 12 and the second range in which the predetermined information can be viewed with respect to the display device 12, the second range being different from the first range. For example, the first range is a range at a shorter distance from the display device 12 than the second range. In addition, for example, the first range is a range of an effective viewing angle having a narrower effective viewing angle with respect to the display device 12 than the second range. Note that the first range and the second range only need to be different, and are not particularly limited. The number of the predetermined ranges is not limited to one or two, and may be appropriately changed.

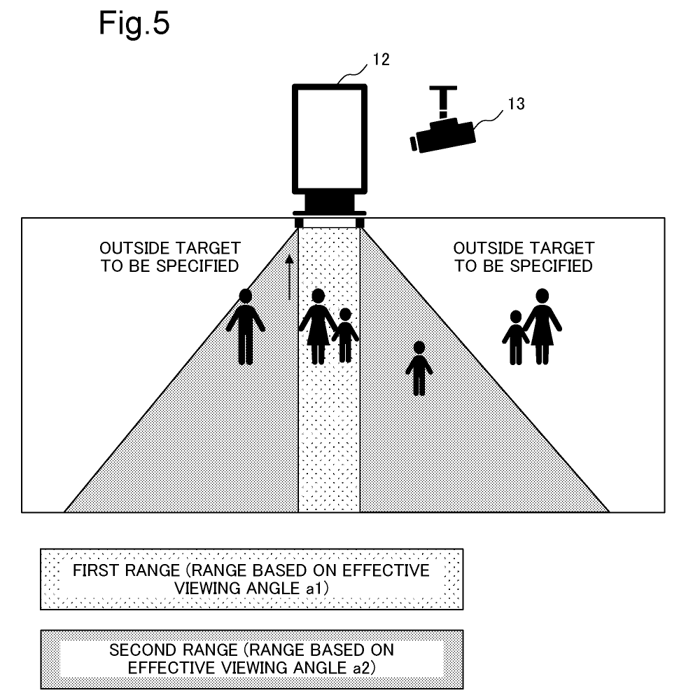

FIG. 5 is an explanatory view illustrating an example in which there are a plurality of predetermined ranges. In FIG. 5, the first range is a range based on an effective viewing angle a1, and the second range is a range based on an effective viewing angle a2. The effective viewing angle a1 is narrower than the effective viewing angle a2. For example, it is easier to look at the predetermined information in the case of being within the first range as compared with the case of being within the second range.

The viewing status analysis unit 105 specifies the viewing status in which the predetermined information has been viewed for each of the first range and the second range. For example, the viewing status analysis unit 105 specifies a viewing status in which the predetermined information has been viewed based on at least one of a direction of a face and a direction of a line of sight of a person in the first range and a viewing status in which the predetermined information has been viewed in the second range based on at least one of a direction of a face and a direction of a line of sight of a person in the second range. For example, in a case where the viewing status is the number of times of viewing, the viewing status analysis unit 105 specifies the number of times of viewing that the predetermined information has been viewed based on at least one of the direction of the face and the direction of the line of sight of the person in the first range and the number of times of viewing that the predetermined information has been viewed in the second range based on at least one of the direction of the face and the direction of the line of sight of the person in the second range.

The recognition status analysis unit 107 specifies the recognition status in which the predetermined information has been recognized for each of the first range and the second range. The recognition status analysis unit 107 specifies a recognition status in which the predetermined information has been recognized in the first range based on a predetermined motion of a person in the first range and a recognition status in which the predetermined information has been recognized in the second range based on a predetermined motion of a person in the second range. For example, when the recognition status is the number of times of recognition, the recognition status analysis unit 107 specifies the number of times of recognition that the predetermined information has been recognized in the first range based on the predetermined motion of the person in the first range and the number of times of recognition that the predetermined information has been recognized in the second range based on the predetermined motion of the person in the second range.

The output unit 109 outputs the person presence status, the viewing status, and the recognition status. An output destination of the output unit 109 is not particularly limited, but is, for example, the terminal 11. An output method by the output unit 109 is not particularly limited, and may be a screen display, voice output, or the like.

For example, the output unit 109 outputs the number of people, the number of times of viewing, and the number of times of recognition. Alternatively, for example, the output unit 109 outputs the number of people, the number of viewers, and the number of recognized persons. Alternatively, for example, the output unit 109 may output the number of people, the number of times of viewing, the number of viewers, the number of times of recognition, and the number of recognized persons. As described above, a combination of examples in which pieces of specific information of the person presence status, the viewing status, and the recognition status is output is not particularly limited.

When the predetermined ranges are the first range and the second range, the output unit 109 outputs the person presence status, the viewing status and the recognition status in the first range, and the viewing status and the recognition status in the second range. When the viewing status is the number of times of viewing and the recognition status is the number of times of recognition, the output unit 109 outputs the number of times of viewing and the number of times of recognition in the first range and the number of times of viewing and the number of times of recognition in the second range.

In addition, the output unit 109 may output a ratio or the like such as the number of viewers with respect to the number of people included in the image, the number of recognized persons with respect to the number of people included in the image, or the like.

For example, the output unit 109 may output a graph of each numerical value included in the person presence status, the viewing status, and the recognition status. The type of the graph is not particularly limited. In addition, for example, the output unit 109 may output the person presence status, the viewing status, and the recognition status in a comparable manner for each time zone. Note that a time period, a month, the day of the week, and the like may be used without being limited to an example of the time zone.

In addition, the output unit 109 may output at least one of the number of times of recognition and the number of recognized persons for each recognition motion.

In addition, a name of a person or the like included in the captured image may be appropriately changed according to an installation place. In addition, the output unit 109 may appropriately output the name. For example, in a case where the display device 12 is installed outdoors or the like, the person may be called a passer-by or a passer. For example, in a case where the display device 12 is installed in a store, the person may be called a customer.

In addition, the predetermined range has been described as a range in which the predetermined information displayed on the display device 12 can be viewed. For example, there is a case where the user desires to perform analysis on a partial region in the captured image. Therefore, the predetermined range may be a range designated by the user. As described above, the predetermined range may be appropriately set.

### Flowchart

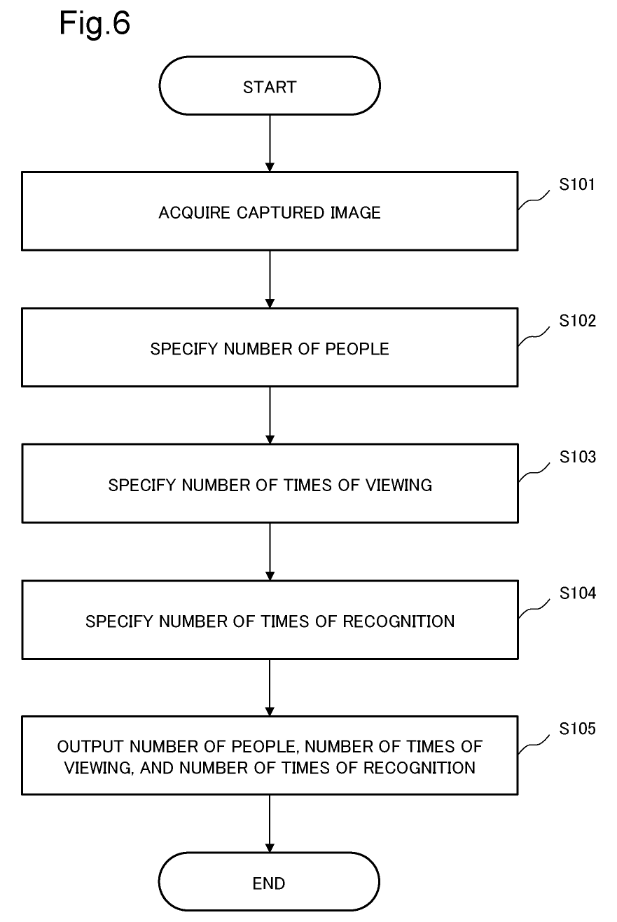

FIG. 6 is a flowchart illustrating an exemplary operation of the information processing device 10. Here, a case where the person presence status is the number of people, the viewing status is the number of times of viewing, and the recognition status is the number of times of recognition will be described as an example.

The acquisition unit 101 acquires a captured image in which the vicinity of the display device 12 that displays predetermined information is captured (step S101). Next, the person presence status analysis unit 103 specifies the number of people included in the captured image (step S102).

Next, the viewing status analysis unit 105 specifies the number of times of viewing that the predetermined information has been viewed based on at least one of a direction of a face or a direction of a line of sight of each person included in the captured image (step S103). The recognition status analysis unit 107 specifies the number of times of recognition that the predetermined information has been recognized based on a predetermined motion with which it is possible to determine that the predetermined information is more gazed at than the viewing, the predetermined motion being made by the person included in the captured image (step S104). The output unit 109 outputs the number of people, the number of times of viewing, and the number of times of recognition (step S105). The information processing device 10 ends the series of processing illustrated in FIG. 6.

It is not possible to know whether information displayed on the display device 12 installed at a place that can be seen by an unspecified large number of people is being actually looked at by people. In particular, in the case of an outdoor advertisement, it is unclear whether the information is being looked at. Therefore, in the first example embodiment, the information processing device 10 acquires a captured image in which the vicinity of the display device 12 that displays predetermined information is captured. Next, the information processing device 10 specifies the number of people included in the captured image. The information processing device 10 specifies the number of times of viewing that the predetermined information has been viewed based on at least one of a direction of a face or a direction of a line of sight of each person included in the captured image. The information processing device 10 specifies the number of times of recognition that the predetermined information has been recognized based on a predetermined motion with which it is possible to determine that the predetermined information is more gazed at than the viewing, the predetermined motion being made by the person included in the captured image. The information processing device 10 outputs the number of people, the number of times of viewing, and the number of times of recognition. As a result, it is possible to facilitate analysis of an effect of the information displayed on the display device 12 installed at the place that can be seen by the unspecified large number of people. That is, it is possible to facilitate the analysis of the effect by displaying the predetermined information on the display device. In particular, in a case where advertisement information is displayed, it is possible to facilitate analysis of an advertisement effect. Even if the person presence status, the viewing status, and the recognition status are other examples, it is possible to similarly facilitate analysis of an effect of the information displayed on the display device 12. For example, when the predetermined information is the advertisement information, the analysis of the advertisement effect can be facilitated.

In addition, the information processing device 10 specifies the number of times of viewing that the predetermined information has been viewed based on at least one of the direction of the face or the direction of the line of sight of a person within a predetermined range in which the predetermined information can be viewed with respect to the display device 12 among the people included in the captured image. In addition, the information processing device 10 specifies the number of times of recognition that the predetermined information has been recognized based on a predetermined motion of the person within the predetermined range. The predetermined range is a predetermined angle with respect to the display device 12. Alternatively, the predetermined range is within a predetermined distance from the display device 12. As a result, the number of times of viewing and the number of times of recognition can be specified with higher accuracy.

A plurality of predetermined ranges may be set. For example, when the predetermined ranges are a first range and a second range, the first range is a range at a shorter distance from the display device 12 than the second range or a range of an effective viewing angle with respect to the display device 12 that is narrower than an effective viewing angle of the second range. The information processing device 10 specifies the number of times of viewing and the number of times of recognition for each of the ranges. As a result, it is possible to perform more detailed analysis according to a position where a person is present.

In addition, the predetermined motion with which it is possible to determine that the predetermined information is more gazed at than the viewing is at least one of a motion of a person approaching the predetermined information, a motion of a person bringing the terminal 11 closer to the predetermined information, a motion of a person pointing his/her finger at the predetermined information, and a motion of the same person viewing the predetermined information a plurality of times. As a result, the information processing device 10 can specify a person who pays more attention to the predetermined information.

In addition, the information processing device 10 specifies the number of viewers who have viewed the predetermined information and the number of recognized persons who have recognized the predetermined information. As a result, it is possible to analyze an effect when the predetermined information is displayed on the display device 12 in more detail.

### Second Example Embodiment

A second example embodiment will be described in detail with reference to the drawings. In the second example embodiment, an example of analyzing an attribute of a person will be further described with respect to the first example embodiment. In the second example embodiment, an example of analyzing an emotion of a person will be further described with respect to the first example embodiment. Hereinafter, the description of content that is duplicate of the description above will be omitted to the extent that description of the second example embodiment is not unclear.

Since an exemplary information processing system including an information processing device 20 may be similar to the information processing system including the information processing device illustrated in FIG. 1, illustration and detailed description thereof will be omitted.

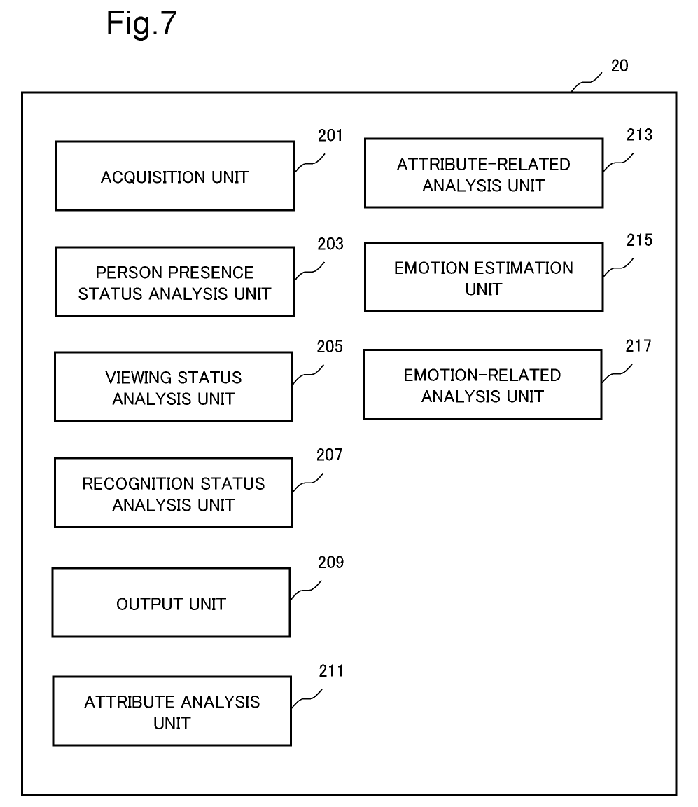

FIG. 7 is a block diagram illustrating an exemplary configuration of the information processing device 20. The information processing device 20 includes an acquisition unit 201, a person presence status analysis unit 203, a viewing status analysis unit 205, a recognition status analysis unit 207, an output unit 209, an attribute analysis unit 211, an attribute-related analysis unit 213, an emotion estimation unit 215, and an emotion-related analysis unit 217.

The acquisition unit 201 has the function of the acquisition unit 101 illustrated in FIG. 2 as a basic function. The person presence status analysis unit 203 has the function of the person presence status analysis unit 103 illustrated in FIG. 2 as a basic function. The viewing status analysis unit 205 has the function of the viewing status analysis unit 105 illustrated in FIG. 2 as a basic function. The recognition status analysis unit 207 has the function of the recognition status analysis unit 107 illustrated in FIG. 2 as a basic function. The output unit 209 has the function of the output unit 109 illustrated in FIG. 2 as a basic function.

As described above, the information processing device 20 newly includes the attribute analysis unit 211, the attribute-related analysis unit 213, the emotion estimation unit 215, and the emotion-related analysis unit 217. Here, since the acquisition unit 201, the person presence status analysis unit 203, the viewing status analysis unit 205, and the recognition status analysis unit 207 may be the same as those in processing examples described in the first example embodiment, detailed description thereof will be omitted.

Here, advertisements are created with targets set in advance in some cases, and also created for an unspecified number of people in other cases. In the case of an advertisement created with targets set in advance, an advertiser desires that more people corresponding to the targets see the advertisement information. Even when the advertisement is not seen by the target people, the advertiser desires to confirm what kind of person is looking at the advertisement. In addition, in the case of an advertisement created for an unspecified number of people, the advertiser wants to confirm what kind of person is looking at the advertisement information.

Therefore, the attribute analysis unit 211 analyzes information regarding an attribute of a person included in a captured image. The attribute is not particularly limited, and may be, for example, gender, age, an age group, composition of people, a traveler, a student, a commuter, and the like. Attributes of the traveler, the student, the commuter, and the like may be specified by belongings or clothes. The composition of people may be one person or a group. The composition of people may be a couple, a married couple, being accompanied by a child, and the like. The composition of people may be estimated from the gender and the age of a person included in a group. Note that an existing technique may be used as an attribute analysis method, and thus detailed description thereof will be omitted.

In addition, the attribute analysis unit 211 may analyze information regarding an attribute of a viewer. In addition, the attribute analysis unit 211 may analyze information regarding an attribute of a recognized person. As described above, the attribute analysis unit 211 may analyze attributes of some people among people included in the captured image. The some people may be designated as viewers, recognized persons, and people at a distance within 2 meters from a display device. In addition, for example, the attribute analysis unit 211 may analyze a combination of attributes. In a case where a user desires to confirm a recognition status of women in their twenties, the attribute analysis unit 211 may analyze people whose attributes correspond to women from recognized persons, and may analyze whether being in one’s twenties from among the women.

The output unit 209 further outputs information regarding an attribute. An output destination of the output unit 209 is not particularly limited as in the first example embodiment, but is, for example, a terminal. As in the first example embodiment, an output method by the output unit 209 is not particularly limited, and may be a screen display, voice output, or the like. Also in the following description, the output destination and the output method by the output unit 209 are not particularly limited.

In addition, for example, the output unit 209 may output a person presence status, a viewing status, and a recognition status for each attribute. When the attribute is an age group, for example, the output unit 209 may output the person presence status, the viewing status, and the recognition status for each age group. As described above, information such as a time period, a month, the day of the week, or time, and the attribute may be output in combination. For example, the output unit 209 may output the person presence status, the viewing status, and the recognition status for each time zone and each attribute. For example, the output unit 209 may output a presence status, a viewing status, and a recognition status for women in the 15:00 zone, a presence status, a viewing status, and a recognition status for men in the 15:00 zone, a presence status, a viewing status, and a recognition status for women in the 16:00 zone, and a presence status, a viewing status, and a recognition status for men in the 16:00 zone.

In addition, the output unit 209 may output a person presence status, a viewing status, and a recognition status corresponding to an attribute designated by the user. The designation of the attribute by the user may be received by an operation on the terminal.

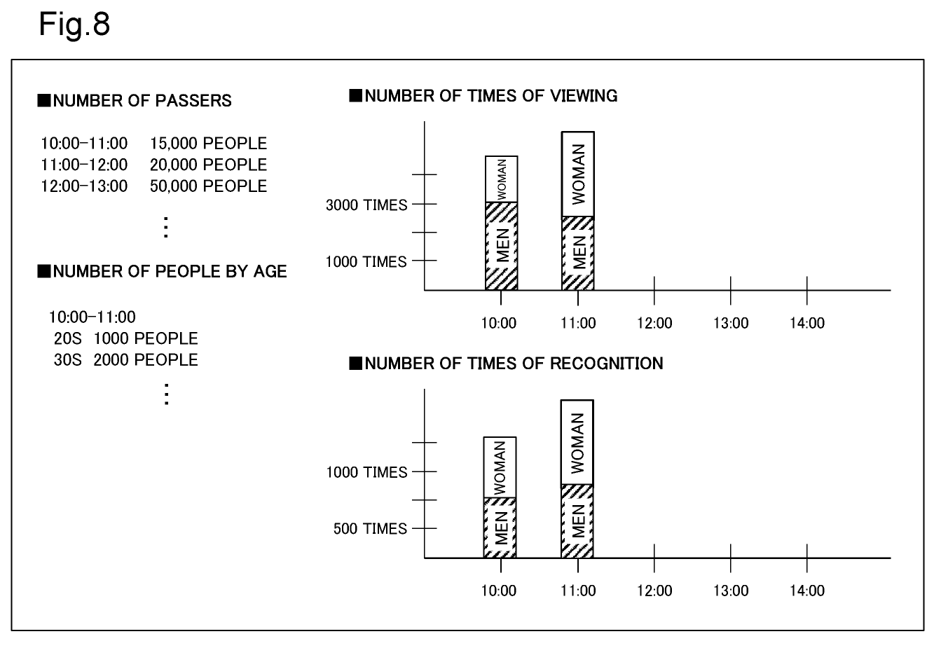

FIG. 8 is an explanatory view illustrating an exemplary screen of the terminal. The screen illustrated in FIG. 8 is, for example, a screen for confirming an advertisement effect in a case where the display device is installed outdoors.

The number of passers is the number of people included in the captured image. On the screen illustrated in FIG. 8, the number of passers is displayed for each time zone as the “number of passers”. In addition, on the screen illustrated in FIG. 8, the number of passers is displayed for each time zone and each age group as the “number of people by age group”. In addition, on the screen illustrated in FIG. 8, as the “number of times of viewing”, the number of times of viewing by men and the number of times of viewing by women are displayed in a graph so as to be identifiable for each time zone. More specifically, the graph as the “number of times of viewing” is a bar graph in which the horizontal axis indicates the time zone and the vertical axis indicates the number of times of viewing. This graph is a bar graph in which the number of times of viewing by women is placed on the number of times of viewing by men in each time zone.

On the screen illustrated in FIG. 8, as the “number of times of recognition”, the number of times of recognition by men and the number of times of recognition by women are displayed in a graph so as to be identifiable for each time zone. More specifically, the graph as the “number of times of recognition” is a bar graph in which the horizontal axis indicates the time zone and the vertical axis indicates the number of times of recognition. This graph is a bar graph in which the number of times of recognition by women is placed on the number of times of recognition by men in each time zone.

According to FIG. 8, the user can confirm a time-series change in the number of passers-by around the display device. In addition, the user can confirm a time-series change in the number of passers-by around the display device by age group. In addition, the user can confirm a time-series change in the number of times of viewing for each gender and a time-series change in the number of times of recognition for each gender.

Next, the attribute-related analysis unit 213 analyzes relevance between information regarding an attribute and predetermined information. As described above, for example, there is a case where a target of advertisement information is set in advance. For example, there are an advertisement for a family with a small child, an advertisement for women, an advertisement for men, an advertisement for those who are in their twenties, an advertisement for a family in their 40s, and an advertisement for seniors. The attribute-related analysis unit 213 analyzes the relevance between the information regarding the attribute and information regarding an attribute targeted by the predetermined information. For example, a method for expressing the relevance is not particularly limited. The relevance may be expressed by match or mismatch, or may be expressed by a level.

The output unit 209 outputs the relevance. The output unit 209 may output the person presence status, the viewing status, and the recognition status for each attribute and each relevance. For example, the output unit 209 may output a person presence status, a viewing status, and a recognition status for an attribute having high relevance. The level of the relevance may be absolute evaluation on whether it is equal to or more than a threshold, or may be relative evaluation.

The attribute-related analysis unit 213 is not limited to the analysis of the relevance, and may analyze a correlation between the predetermined information and information regarding an attribute of a person. For example, the attribute-related analysis unit 213 may also input a prompt to ask generative artificial intelligence (AI) a question about the correlation between the predetermined information and the information regarding the attribute of the person, and acquire an answer to the question from the generative AI. The generative AI may be a language model. In addition, the language model may be, for example, a large-scale language model. Note that the language model may be provided in the information processing device 20 or may be provided in another system. Then, the output unit 209 may output information regarding the correlation. For example, there is a case where the user finds out that a person having an attribute different from a target is gazing at an advertisement when the user confirms the person presence status, the viewing status, and the recognition status for each attribute. In such a case, the user can confirm a correlation between information regarding the attribute and the advertisement.

The emotion estimation unit 215 estimates an emotion of a person included in the captured image. Specifically, for example, the emotion estimation unit 215 estimates a change in the emotion of the person using face images of the person included in the captured images in time series. For example, the time-series change in the emotion of the person is a difference between an emotion before looking at an advertisement, an emotion while looking at the advertisement, and an emotion after looking at the advertisement. The emotion estimation unit 215 can analyze a facial expression of the person and estimate the emotion of the person. Since it is sufficient to use a known technique for estimating the emotion by the analysis of the facial expression of the person, detailed description thereof will be omitted. The emotion of the person is a psychological state of the person. Examples of the emotion of the person include fun, joy, accomplishment, and relaxation. Other examples of the emotion of the person include anxiety, depression, sorrow, anger, and irritation. That is, the emotion of the person indicates the mood of the person. The emotion of the person is not limited thereto.

In addition, the emotion estimation unit 215 may estimate an emotion of a viewer. In addition, the emotion estimation unit 215 may estimate an emotion of a recognized person. As described above, the emotion estimation unit 215 may estimate emotions of target people by targeting some people among people included in the captured image. The some people may be designated as a viewer, a recognized person, a person at a distance within 2 meters from the display device, a person corresponding to a specific attribute, a combination thereof, or the like. A method of the combination is not particularly limited, and for example, the emotion estimation unit 215 may use female viewers in their twenties as emotion estimation targets.

In addition, the output unit 209 outputs information regarding the estimated emotion. For example, the output unit 209 may output the person presence status, the viewing status, and the recognition status for each emotion.

In addition, the emotion-related analysis unit 217 analyzes a relationship between the emotion of the person and the predetermined information. A method for expressing the relationship is not particularly limited. For example, in a case where the emotion of the person is sad although the content of the predetermined information is cheerful, the emotion-related analysis unit 217 may analyze that there is no relationship between the emotion of the person and the predetermined information. For example, in a case where the content of the predetermined information is cheerful and the emotion of the person seems to have fun, the emotion-related analysis unit 217 may analyze that there is a relationship between the emotion of the person and the predetermined information.

The output unit 209 outputs information regarding the relationship.

The analysis of the attribute of the person and the estimation of the emotion of the person are examples, and behavior of the person may be analyzed in more detail. For example, in a case where an installation place of the display device is a retail store, whether a customer takes action of purchasing a specific product after viewing advertisement information on the specific product may be analyzed.

In addition, for example, in a case where voice information is included in advertisement information, whether a person reacts to sound may be analyzed. Specifically, a difference in an advertisement effect between a person wearing earphones and a person not wearing earphones may be analyzed. For example, a viewing status or a recognition status of the person wearing earphones and a viewing status or a recognition status of the person not wearing earphones may be displayed on the terminal 11.

In addition, for example, the output of the display device may be controlled in such a manner that the content of an advertisement displayed on the display device is switched according to an attribute of a recognized person included in the captured image. In addition, the output of the display device may be controlled in such a manner that a coupon is displayed on the display device according to the attribute of the recognized person included in the captured image. In particular, for example, when the installation place is a retail store, it is expected that the number of people in the vicinity of the display device is relatively small. Therefore, the case of being installed in the retail store or the like is suitable for optimizing the display content according to the people in the vicinity of the display device.

### Flowchart

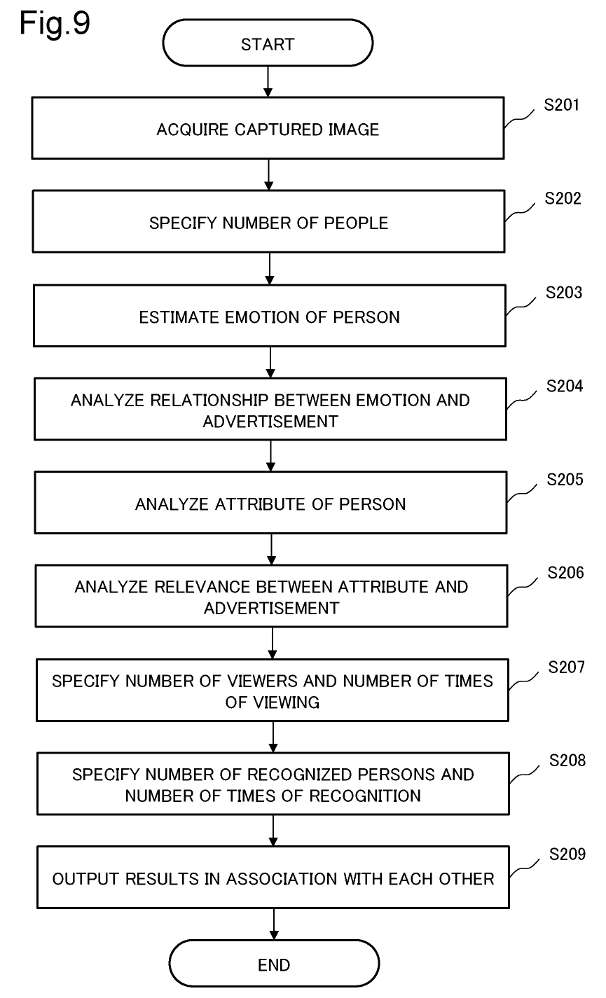

FIG. 9 is a flowchart illustrating an exemplary operation of the information processing device 20. The acquisition unit 201 acquires a captured image in which the vicinity of the display device that displays predetermined information is captured (step S201). Next, the person presence status analysis unit 203 specifies the number of people included in the captured image (step S202).

Next, the emotion estimation unit 215 estimates information regarding an emotion of each person included in the captured image (step S203). Then, the emotion-related analysis unit 217 analyzes a relationship between the information regarding the emotion of the person and advertisement information (step S204).

The attribute analysis unit 211 analyzes information regarding an attribute of the person included in the captured image (step S205). The attribute-related analysis unit 213 analyzes the relevance between the information regarding the attribute and the advertisement information (step S206).

Next, based on at least one of a direction of a face and a direction of a line of sight of the person included in the captured image, the viewing status analysis unit 205 specifies the number of viewers who have viewed the predetermined information and the number of times of viewing that the predetermined information has been viewed (step S207).

The recognition status analysis unit 207 specifies the number of times of recognition that the predetermined information has been recognized based on a predetermined motion with which it is possible to determine that the predetermined information is more gazed at than the viewing, the predetermined motion being made by the person included in the captured image (step S208).

The output unit 209 outputs results in association with each other (step S209). The information processing device 20 ends the series of processing illustrated in FIG. 9. The execution order of each step is not particularly limited. The person whose emotion is to be estimated by the emotion estimation unit 215 is not particularly limited, and can be set as appropriate. Similarly, the person whose attribute is to be analyzed by the attribute analysis unit 211 is not particularly limited, and can be appropriately set.

As described above, the information processing device 20 analyzes the information regarding the attribute of the person included in the captured image in the second example embodiment. For example, it is possible to analyze what kind of attribute people often looking at an advertisement have or what kind of attribute people not looking at the advertisement have. Therefore, the advertisement effect can be analyzed in more detail.

In addition, the information processing device 20 analyzes the relevance between the information regarding the attribute and the predetermined information. As a result, it is possible to analyze the presence status, the viewing status, the recognition status, and the like of the person who is the target of the advertisement. Whether the person who is the target of the advertisement is actually looking at the advertisement or the like can be analyzed. Therefore, the advertisement effect can be analyzed in more detail.

In addition, the information processing device 20 estimates the emotion of the person included in the captured image. Then, the information processing device 20 analyzes the relationship between the emotion of the person and the predetermined information.

Thus, the description of the example embodiments has ended. For example, the example embodiments may be appropriately modified. Modifications will be illustrated hereinafter.

### Modifications

FIG. 5 illustrates the example of the first range based on the effective viewing angle a1 and the second range based on the effective viewing angle a2. It is easier to look at the predetermined information in the case of being within the first range as compared with the case of being within the second range. Therefore, the viewing status analysis unit 205 may specify the number of viewers who view the predetermined information from people in the first range and the second range and the number of times of viewing that the predetermined information has been viewed. Then, the recognition status analysis unit 207 may specify the number of recognized persons who recognize the predetermined information from the people in the first range and the number of times of recognition that the predetermined information has been recognized. As described above, at least partial ranges in which the viewing status and the recognition status are analyzed may be different.

In addition, the number of recognized persons who have moved from the second range to the first range and recognized the predetermined information may be analyzed.

The description of the modifications has ended. The example embodiments may be appropriately combined. In addition, the example embodiments and the modifications may be appropriately combined. In addition, the functional units included in the information processing devices 10 and 20 can be changed as appropriate. For example, the information processing device 10 includes the acquisition unit 101, the person presence status analysis unit 103, the recognition status analysis unit 107, and the output unit 109. For example, the information processing device 20 includes the acquisition unit 201, the person presence status analysis unit 203, the viewing status analysis unit 205, the recognition status analysis unit 207, the output unit 209, and the attribute analysis unit 211. For example, the information processing device 20 includes the acquisition unit 201, the person presence status analysis unit 203, the viewing status analysis unit 205, the recognition status analysis unit 207, the output unit 209, and the emotion estimation unit 215.

The configurations of the information processing devices 10 and 20 are not particularly limited. For example, the functional units of the information processing device 10 or 20 may be implemented by one device. Alternatively, for example, the functional units or databases of the information processing device 10 or 20 may be implemented by different devices from each other and may be configured as a system. For example, the functional units of the information processing device 10 or 20 may be configured by a plurality of servers and implemented as a system. For example, a system may be implemented that includes a database server including each database and a server including each functional unit. A system including a server including some functional units of the information processing device 10 or 20 and a server including the other functional units of the information processing device 10 or 20 may be achieved. The number of servers is not particularly limited.

In addition, the terminal 11 may include the functional units of the information processing device 10 or 20. For example, an application program in which the functional units of the information processing device 10 or 20 are coded may be installed in the terminal 11.

In addition, processing of generating information or the like to be displayed on the terminal 11 may be performed by a functional unit included in the information processing devices 10 and 20 such as the output units 109 and 209. This processing may be performed by the terminal 11. That is, the terminal 11 may generate screen information to be displayed on the terminal 11, based on the data received from the information processing device 10 or 20, and display a screen, based on the screen information.

User interfaces in the example embodiments are examples, and various changes can be made.

### Exemplary Hardware Configuration of Computer

Next, an exemplary hardware configuration in a case where each device such as the information processing device 10 or 20 or the terminal 11 is implemented by a computer will be described.

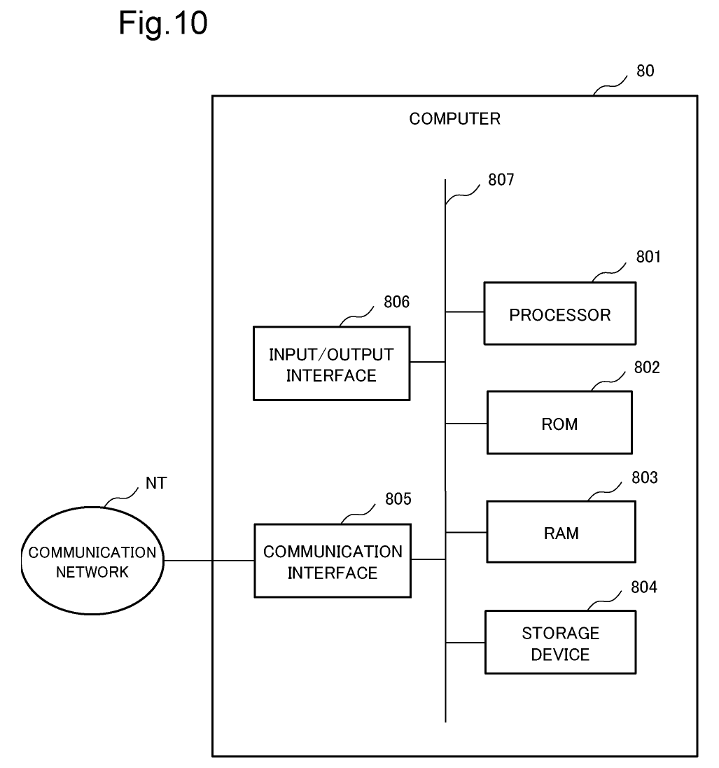

FIG. 10 is an explanatory diagram illustrating the exemplary hardware configuration of the computer. For example, it is also possible to implement a part or the whole of each device by using any combination of a computer 80 as illustrated in FIG. 10 and a program.

The computer 80 includes, for example, a processor 801, a read only memory (ROM) 802, a random access memory (RAM) 803, and a storage device 804. The computer 80 includes a communication interface 805 and an input/output interface 806. The components are connected via, for example, a bus 807. The number of each component is not particularly limited, and the number of each component is one or more.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, or a combination thereof, or the like can be used and is not particularly limited.

The computer 80 includes the ROM 802, the RAM 803, the storage device 804, and the like. Examples of the storage device 804 include a semiconductor memory such as a flash memory, a hard disk drive (HDD), and a solid state drive (SSD). For example, the storage device 804 stores an operating system (OS) program, an application program, a program according to each example embodiment, and the like. Alternatively, the ROM 802 stores an application program, a program according to an example embodiments, and the like. The RAM 803 is used as a work area for the processor 801.

The processor 801 loads a program stored in the storage device 804, the ROM 802, or the like. The processor 801 executes each process coded in the program. The processor 801 may download various programs via the communication network NT. The processor 801 functions as a part or the whole of the computer 80. The processor 801 may execute the processes or instructions in the flowcharts illustrated in the drawings, based on the program.

The communication interface 805 is connected to the communication network NT such as a local area network (LAN) or a wide area network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from and to the external device or the external computer 80.

The input/output interface 806 is connected to at least any one of an input device, an output device, and an input/output device. A method of the connection may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may include some components illustrated in FIG. 10. The computer 80 may include a component other than those illustrated in FIG. 10. For example, the computer 80 may include a drive device. The processor 801 may read a program or data stored in a recording medium attached to a drive device or the like into the RAM 803. Examples of the non-transitory tangible recording medium include an optical disk, a flexible disk, a magneto-optical disk, and a Universal Serial Bus (USB) memory.

The computer 80 may include various sensors (not illustrated). The types of the sensors are not particularly limited. The computer 80 may include an imaging device capable of capturing images and videos.

Thus, the description of the hardware configuration of each device has ended. A method for implementing each device has various modifications. For example, each device may be implemented by any combination of a computer and a program different for each component. A plurality of components included in each device may be implemented by any combination of one computer and a program.

Some or all of components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be disposed in a centralized manner or in a distributed manner.

The analysis method described in each example embodiment may be implemented by being executed by a computer such as the information processing device 10 or 20.

Each program described in each example embodiment is recorded in a computer-readable recording medium such as an HDD, an SSD, a flexible disk, an optical disc, a magneto-optical disc, or a USB memory. Each program is read from the recording medium by the computer to be executed. Each program may be distributed via the communication network NT.

The function of each component of the information processing devices 10 and 20 described above may be implemented by dedicated hardware such as a computer. Alternatively, each component may be implemented by software. Alternatively, each component may be implemented by a combination of hardware and software.

While the present disclosure has been described with reference to the example embodiments, the present disclosure is not limited to the example embodiments described above. The configurations and details of the present disclosure may include example embodiments to which various changes that can be grasped by those skilled in the art within the scope of the present disclosure are applied. The present disclosure may include example embodiments in which the matters described in the present specification are appropriately combined or replaced, as necessary. For example, the matters described with a specific example embodiment can be applied to other example embodiments as long as no contradiction occurs. For example, although a plurality of operations is described in order in the form of a flowchart, the described order does not limit the order in which the plurality of operations is executed. Thus, when each example embodiment is carried out, the order of the plurality of operations can be changed within a range that does not interfere with the content.

Some or all of the example embodiments described above may also be described as Supplementary Notes below. However, some or all of the example embodiments described above are not limited to the following.

### Supplementary Note 1

An information processing device including:

an acquisition means for acquiring a captured image in which the vicinity of a display device that displays predetermined information is captured;

a person presence status analysis means for specifying the number of people included in the captured image;

a viewing status analysis means for specifying the number of times of viewing that the predetermined information has been viewed based on at least one of a direction of a face or a direction of a line of sight of each of the people included in the captured image;

a recognition status analysis means for specifying the number of times of recognition that the predetermined information has been recognized based on a predetermined motion with which it is possible to determine that the predetermined information is more gazed at than the viewing, the predetermined motion being made by each of the people included in the captured image; and

an output means for outputting the number of people, the number of times of viewing, and the number of times of recognition.

### Supplementary Note 2

The information processing device according to Supplementary Note 1, wherein

the viewing status analysis means specifies the number of times of viewing that the predetermined information has been viewed based on at least one of a direction of a face or a direction of a line of sight of a person who is within a range in which the predetermined information is viewable with respect to the display device among the people included in the captured image, and

the recognition status analysis means specifies the number of times of recognition that the predetermined information has been recognized based on the predetermined motion of the person within the range.

### Supplementary Note 3

The information processing device according to Supplementary Note 2, wherein

the range is a predetermined angle with respect to the display device or is within a predetermined distance from the display device.

### Supplementary Note 4

The information processing device according to Supplementary Note 2 or 3, wherein

the range includes a first range in which the predetermined information is viewable with respect to the display device and a second range in which the predetermined information is viewable with respect to the display device, the second range being different from the first range,

the viewing status analysis means specifies the number of times of viewing that the predetermined information has been viewed for each of the first range and the second range,

the recognition status analysis means specifies the number of times of recognition that the predetermined information has been recognized for each of the first range and the second range, and

the output means outputs the number of times of viewing and the number of times of recognition in the first range and the number of times of viewing and the number of times of recognition in the second range.

### Supplementary Note 5

The information processing device according to Supplementary Note 4, wherein

the first range is a range of an effective viewing angle with respect to the display device that is narrower than an effective viewing angle of the second range.

### Supplementary Note 6

The information processing device according to Supplementary Note 4, wherein

the first range is a range at a shorter distance from the display device than the second range.

### Supplementary Note 7

The information processing device according to any one of Supplementary Notes 1 to 6, wherein

the predetermined motion is at least one of a motion of each of the people approaching the predetermined information, a motion of each of the people bringing a terminal closer to the predetermined information, a motion of each of the people pointing his/her finger at the predetermined information, and a motion of the same person, among the people, who views the predetermined information a plurality of times.

### Supplementary Note 8

The information processing device according to any one of Supplementary Notes 1 to 7, wherein

the viewing status analysis means specifies the number of viewers who have viewed the predetermined information based on at least one of a direction of a face or a direction of a line of sight of each of the people included in the captured image,

the recognition status analysis means specifies the number of recognized persons who have recognized the predetermined information based on at least one of the direction of the face or the direction of the line of sight of each of the people included in the captured image, and

the output means further outputs the number of the viewers and the number of the recognized persons.

### Supplementary Note 9

The information processing device according to any one of Supplementary Notes 1 to 8, further including

an attribute analysis means for analyzing information regarding an attribute of each of the people included in the captured image,

wherein the output means further outputs the information regarding the attribute.

### Supplementary Note 10

The information processing device according to Supplementary Note 9, further including

an attribute-related analysis means for analyzing relevance between the information regarding the attribute and the predetermined information,

wherein the output means outputs the relevance.

### Supplementary Note 11

The information processing device according to any one of Supplementary Notes 1 to 10, further including:

an emotion estimation means for estimating an emotion of each of the people included in the captured image; and

an emotion-related analysis means for analyzing a relationship between the emotion of each of the people and predetermined information,

wherein the output means outputs information regarding the relationship.

### Supplementary Note 12

An information processing device including:

a person presence status analysis means for specifying a presence status of a person included in a captured image in which the vicinity of a display device that displays predetermined information is captured;

a viewing status analysis means for specifying a viewing status in which the predetermined information has been viewed based on at least one of a direction of a face or a direction of a line of sight of the person included in the captured image;

a recognition status analysis means for specifying a recognition status in which the predetermined information is recognized based on a predetermined motion of the person included in the captured image, the predetermined motion determined to be gazing at the predetermined information more than the viewing; and

an output means for outputting the presence status, the viewing status, and the recognition status.

### Supplementary Note 13

An analysis method in which at least one computer executes processing of:

acquiring a captured image in which a vicinity of a display device that displays predetermined information is captured;

specifying the number of people included in the captured image;

specifying the number of times of viewing that the predetermined information has been viewed based on at least one of a direction of a face or a direction of a line of sight of each of the people included in the captured image;

specifying the number of times of recognition that the predetermined information has been recognized based on a predetermined motion with which it is possible to determine that the predetermined information is more gazed at than the viewing, the predetermined motion being made by each of the people included in the captured image; and

outputting the number of people, the number of times of viewing, and the number of times of recognition.

### Supplementary Note 14

An analysis method in which at least one computer executes processing of:

specifying a presence status of a person included in a captured image in which the vicinity of a display device that displays predetermined information is captured;

specifying a viewing status in which the predetermined information has been viewed based on at least one of a direction of a face or a direction of a line of sight of the person included in the captured image;

specifying a recognition status in which the predetermined information is recognized based on a predetermined motion of the person included in the captured image, the predetermined motion determined to be gazing at the predetermined information more than the viewing; and

outputting the presence status, the viewing status, and the recognition status.

### Supplementary Note 15

A program for causing at least one computer to execute processing of:

acquiring a captured image in which a vicinity of a display device that displays predetermined information is captured;

specifying the number of people included in the captured image;

specifying the number of times of viewing that the predetermined information has been viewed based on at least one of a direction of a face or a direction of a line of sight of each of the people included in the captured image;

specifying the number of times of recognition that the predetermined information has been recognized based on a predetermined motion with which it is possible to determine that the predetermined information is more gazed at than the viewing, the predetermined motion being made by each of the people included in the captured image; and

outputting the number of people, the number of times of viewing, and the number of times of recognition.

### Supplementary Note 16

A program for causing at least one computer to execute processing of:

specifying a presence status of a person included in a captured image in which the vicinity of a display device that displays predetermined information is captured;

specifying a viewing status in which the predetermined information has been viewed based on at least one of a direction of a face or a direction of a line of sight of the person included in the captured image;

specifying a recognition status in which the predetermined information is recognized based on a predetermined motion of the person included in the captured image, the predetermined motion determined to be gazing at the predetermined information more than the viewing; and

outputting the presence status, the viewing status, and the recognition status.

### Supplementary Note 17

A non-transitory computer-readable recording medium storing a program for causing at least one computer to execute processing of:

acquiring a captured image in which a vicinity of a display device that displays predetermined information is captured;

a person presence status analysis means for specifying the number of people included in the captured image;

specifying the number of times of viewing that the predetermined information has been viewed based on at least one of a direction of a face or a direction of a line of sight of each of the people included in the captured image;

specifying the number of times of recognition that the predetermined information has been recognized based on a predetermined motion with which it is possible to determine that the predetermined information is more gazed at than the viewing, the predetermined motion being made by each of the people included in the captured image; and

outputting the number of people, the number of times of viewing, and the number of times of recognition.

### Supplementary Note 18

A non-transitory computer-readable recording medium storing a program for causing at least one computer to execute processing of:

specifying a presence status of a person included in a captured image in which the vicinity of a display device that displays predetermined information is captured;

specifying a viewing status in which the predetermined information has been viewed based on at least one of a direction of a face or a direction of a line of sight of the person included in the captured image;

specifying a recognition status in which the predetermined information is recognized based on a predetermined motion of the person included in the captured image, the predetermined motion determined to be gazing at the predetermined information more than the viewing; and

outputting the presence status, the viewing status, and the recognition status.

Some or all of the configurations described in Supplementary Notes 2 to 11 subordinate to Supplementary Note 1 described above can also be subordinate to Supplementary Notes 12 to 18 with a subordinate relationship similar to that of Supplementary Notes 2 to 11. Some or all of the configurations described in the Supplementary Notes can be similarly dependent on not only the Supplementary Notes 1 and 12 to 18, but also various pieces of hardware and software, and various recording means or systems for recording software without departing from the above-described example embodiments.

According to the present disclosure, it is possible to facilitate the analysis of the effect of the information displayed on the display device installed at the place that can be seen by the unspecified number of people.

1. An information processing device comprising:
at least one memory configured to store instructions; and
at least one processor configured to execute the instructions to:
acquire a captured image in which a vicinity of a display device that displays predetermined information is captured;
specify a number of people included in the captured image;
specify a number of times of viewing that the predetermined information has been viewed based on at least one of a direction of a face or a direction of a line of sight of each of the people included in the captured image;
specify a number of times of recognition that the predetermined information has been recognized based on a predetermined motion with which it is possible to determine that the predetermined information is more gazed at than the viewing, the predetermined motion being made by each of the people included in the captured image; and
output the number of people, the number of times of viewing, and the number of times of recognition.

2. The information processing device according to claim 1, wherein the at least one processor is further configured to execute the instructions to:
specify a number of times of viewing that the predetermined information has been viewed based on at least one of a direction of a face or a direction of a line of sight of a person who is within a range in which the predetermined information is viewable with respect to the display device among the people included in the captured image; and
specify a number of times of recognition that the predetermined information has been recognized based on the predetermined motion of the person within the range.

3. The information processing device according to claim 2, wherein
the range is a predetermined angle with respect to the display device or is within a predetermined distance from the display device.

4. The information processing device according to claim 2, wherein
the range includes a first range in which the predetermined information is viewable with respect to the display device and a second range in which the predetermined information is viewable with respect to the display device, the second range being different from the first range, and the at least one processor is further configured to execute the instructions to:
specify a number of times of viewing that the predetermined information has been viewed for each of the first range and the second range;
specify a number of times of recognition that the predetermined information has been recognized for each of the first range and the second range; and
output the number of times of viewing and the number of times of recognition in the first range and the number of times of viewing and the number of times of recognition in the second range.

5. The information processing device according to claim 1, wherein
the predetermined motion is at least one of a motion of each of the people approaching the predetermined information, a motion of each of the people bringing a terminal closer to the predetermined information, a motion of each of the people pointing his/her finger at the predetermined information, and a motion of a same person, among the people, who views the predetermined information a plurality of times.

6. The information processing device according to claim 1, wherein the at least one processor is further configured to execute the instructions to:
specify a number of viewers who have viewed the predetermined information based on at least one of a direction of a face or a direction of a line of sight of each of the people included in the captured image;
specify a number of recognized persons who have recognized the predetermined information based on at least one of the direction of the face or the direction of the line of sight of each of the people included in the captured image; and
further output the number of the viewers and the number of the recognized persons.

7. The information processing device according to claim 1, wherein the at least one processor is further configured to execute the instructions to:
analyze information regarding an attribute of each of the people included in the captured image; and
further output the information regarding the attribute.

8. The information processing device according to claim 1, wherein the at least one processor is further configured to execute the instructions to:
estimate an emotion of each of the people included in the captured image; and
analyze a relationship between the emotion of each of the people and predetermined information; and
output information regarding the relationship.

9. An analysis method for causing a computer to execute:
acquiring a captured image in which a vicinity of a display device that displays predetermined information is captured;
specifying a number of people included in the captured image;
specifying a number of times of viewing that the predetermined information has been viewed based on at least one of a direction of a face or a direction of a line of sight of each of the people included in the captured image;
specifying a number of times of recognition that the predetermined information has been recognized based on a predetermined motion with which it is possible to determine that the predetermined information is more gazed at than the viewing, the predetermined motion being made by each of the people included in the captured image; and
outputting the number of people, the number of times of viewing, and the number of times of recognition.

10. A non-transitory computer-readable recording medium storing a program for causing a computer to execute processing of:
acquiring a captured image in which a vicinity of a display device that displays predetermined information is captured;
specifying a number of people included in the captured image;
specifying a number of times of viewing that the predetermined information has been viewed based on at least one of a direction of a face or a direction of a line of sight of each of the people included in the captured image;
specifying a number of times of recognition that the predetermined information has been recognized based on a predetermined motion with which it is possible to determine that the predetermined information is more gazed at than the viewing, the predetermined motion being made by each of the people included in the captured image; and
outputting the number of people, the number of times of viewing, and the number of times of recognition.
